(19) United States
(12) Patent Application Publication
(10) Pub. No.: US 2010/0289262 A1
(43) Pub. Date: Nov. 18, 2010

(54) FLANGE COUPLING AND METAL PIPE JOINING STRUCTURE

(76) Inventor: Masato Kobayashi, Hiroshima (JP)

Correspondence Address: MEREK, BLACKMON & VOORHEES, LLC, 673 S. WASHINGTON ST, ALEXANDRIA, VA, 22314, US

(21) Appl. No.: 12/735,258

(22) PCT Filed: Jan. 16, 2009
(86) PCT No.: PCT/JP2009/050507

§ 371 Date: Jun. 25, 2010

(30) Foreign Application Priority Data
Jan. 23, 2008 (JP) 2008-012866

(51) Int. Cl. F16L 23/18; B23P 11/00

(52) U.S. Cl. 285/363; 29/525.13

(57) ABSTRACT

A metal pipe coupling (1) has a sleeve (2a) having, at one end thereof, an insertion hole having a circular cylindrical surface (a1) into which an end of a metal pipe (4) is inserted, a flange (2b) formed at the other end of the sleeve (2a), and a doughnut portion (2d) extending radially inwardly from the deepest position in the direction of the central axis. The doughnut portion (2d) has an annular surface (a2) having a width corresponding to the wall thickness of the metal pipe (4), and the side surface of the metal pipe (4) makes contact with the annular surface (a2) when the metal pipe (4) is inserted into the sleeve. The circular cylindrical surface (a1) and the outer peripheral surface of the metal pipe (4) are bonded to each other by an adhesive agent. Metal pipe couplings (1) are coupled to each other by bolts (5a) and nuts (5b) busing bolt holes (3a) provided in flanges (3).

### CROSS-REFERENCE TO RELATED APPLICATION

The present application claims the priority under 35 U.S.C. 119 of Japanese Application No. 2008-012866, filed Jan. 23, 2008, which is hereby incorporated herein by reference in its entirety.

1. Field of the Invention

This invention relates to a flange coupling for joining metal pipes such as hydraulic pipes, and a metal pipe joining structure making use of a flange coupling.

2. Prior Art

A metal pipe coupling comprising a cylindrical portion and an outer flange has been known from Japanese Patent Laid Open Publication No. 7-301215. One side surface of the cylindrical portion is joined to an end of a steel pipe by welding. The outer flange is formed on an outer periphery of the other side of the cylindrical portion so as to protrude outwardly. Here, the flange has a plurality of bolt holes, and thereby, two outer flanges are fastened face to face with bolts.

Japanese Patent Laid Open Publication No. 9-60774 discloses a technique for joining a steel pipe and a flange coupling with a male screw on the outer periphery of the steel pipe and a female screw on the flange coupling instead of a welded junction. The flange coupling couples two metal pipes by putting a doughnut-like flange portion 43 having a plurality of bolt holes near respective small brim portions 45 and integrating them by fastening bolts and nuts, wherein an engaging portion is provided on the circumference, and the flange portion 43 is loosely fitted to a step of the engaging portion. Here, the flange coupling forms a loose flange. In this technique, the end of the steel pipe must be molded into a male screw beforehand.

Japanese Patent Laid Open Publication No. 2002-332633 discloses a technique for joining metal pipes with an adhesive agent. In this technique, two metal pipes to be joined are arranged in a line, a cylindrical joining member 40 is located between ends of the facing metal pipes, and then, the ends of the metal pipes are respectively inserted into the ends of the joining member 40 and bonded by the adhesive agent. The flange member 40 is freely set at the junction between the metal pipes, and the flange member 40 is narrowed by reducing an inside diameter of the flange member after inserting the ends of the metal pipes therein.

### DISCLOSURE OF THE INVENTION

### Problems to be Solved by the Invention

In joining metal pipes, it is desired to simplify work at the site as much as possible. Welding or screwing is a lot of trouble, whereas joining with an adhesive agent is easy. However, when a plumbing structure is exposed to fire, the adhesive agent melts or burns, and therefore, the cylindrical members can not keep their positions. Accordingly, when external forces are applied to a cylindrical member as another member contacts it, there is some fear that the cylindrical member will easily slide or come off of the metal pipe and that fluids in the pipe will leak, all at once.

In Japanese Patent Laid Open Publication No. 9-60774, a corrosion-resistant core made of synthetic resin, which is screwed to the flange, is provided on the inside of a steel pipe. However, it burns and disappears at the time of fire.

The present invention aims to prevent the fluids in the pipe from leaking in large quantities, or joined members from dripping, by preventing the joined members in an adhesive joint from sliding or coming off at the time of fire.

The present inventor clarified, in a prior application (Japanese Patent Application No. 2007-337449), that steel pipes or steel products can be joined with an adhesive agent through couplings for adhesive joints so as to have a strength equal to the strength of a welded joint. On the other hand, the flange coupling in the present invention is so constructed that the metal pipe is joined to the flange coupling, and then flange couplings are joined by bolts and nuts. That is, the present invention provides a flange coupling for an adhesive joint and proposes to expand the use of adhesive joints by reducing the time for manufacturing or working pipes and by lowering costs without using fire as with a welded joint.

### Means to Solve the Problem

In order to achieve the above-mentioned aims, a flange coupling of the present invention is characterized by a sleeve portion having an insertion hole having a circular cylindrical surface, an end of a metal pipe being inserted into one end of the sleeve portion, an end surface extending radially outward with respect to a central axis of the sleeve portion at the other end thereof, and a doughnut portion extending radially inward with respect to the central axis at the deepest position in the direction of the central axis and an annular surface having a width corresponding to the wall thickness of the metal pipe. The doughnut portion has a surface for joining the annular surface to the end surface of the sleeve portion. A circumferential cavity portion for fitting the O-ring is provided on the annular surface.

A metal pipe joining structure of the present invention is characterized by a metal pipe coupling, a metal pipe, an adhesive agent and bolts and nuts. The metal pipe coupling comprises sleeve portions and a flange portion. One of the sleeve portions has an insertion hole having a circular cylindrical surface at one end thereof and an end surface extending radially outward with respect to the central axis at the other end thereof. The other of the sleeve portions is formed to the deepest position in the direction of the central axis, the annular surface having the circumferential cavity portion for fitting the O-ring and a width corresponding to a wall thickness of a metal pipe. The flange portion has a plurality of bolt holes. One end of the metal pipe is inserted into the insertion hole having the circular cylindrical surface, and one end surface of the pipe makes contact with the annular surface. An outer peripheral surface of the metal pipe and the circular cylindrical surface are bonded to each other by the adhesive agent. By means of bolts and nuts, the bolts pass through the bolt holes, and an end surface of one of the sleeve portions is drawn up to an end surface of the other of the sleeve portions.

### EFFECTS OF THE INVENTION

According to the invention, it is possible to provide a technique for joining pipes to a flange coupling by means of bolts and nuts and an adhesive agent. According to this, it is possible to reduce the time for manufacturing or working pipes and to lower costs without using fire as with welded joints. Furthermore, it is possible to prevent the adhesive agent from dripping.

Moreover, even if the adhesive agent disappears when the plumbing structure is exposed to fire, it is possible to prevent the fluids in the pipe leaking in large quantities, because the extraction of the pipe can be controlled by contact between a radial surface of a joining member and one end of the metal pipe.

### BRIEF DESCRIPTION OF THE DRAWINGS

FIG. 1 is a perspective view showing two metal pipes joined through two sets of metal pipe couplings in accordance with the present invention.

FIG. 2A is a side view of a metal pipe coupling according to the present invention.

FIG. 2B is a sectional view of the metal pipe coupling of FIG. 2A.

FIG. 3 is a sectional view seen from the front, showing a state in which an end of a metal pipe is inserted into a coupling cylindrical member of the metal pipe coupling and joined with an adhesive agent.

FIGS. 4A-4D are sectional views showing the metal pipe coupling in use.

FIGS. 5A-5C shows various positions of a pipe in a sleeve according to the present invention.

FIG. 6 is a sectional view of another embodiment of metal pipe coupling sleeves of the present invention.

FIG. 7 is a sectional view of still another embodiment of a metal pipe coupling sleeve of the present invention.

FIGS. 8A-8E are sectional views of metal pipe coupling sleeves of yet other embodiments of the present invention.

FIGS. 9A and 9B are sectional views of metal pipe coupling sleeves of other embodiments of the present invention.

### PREFERRED EMBODIMENTS OF THE INVENTION

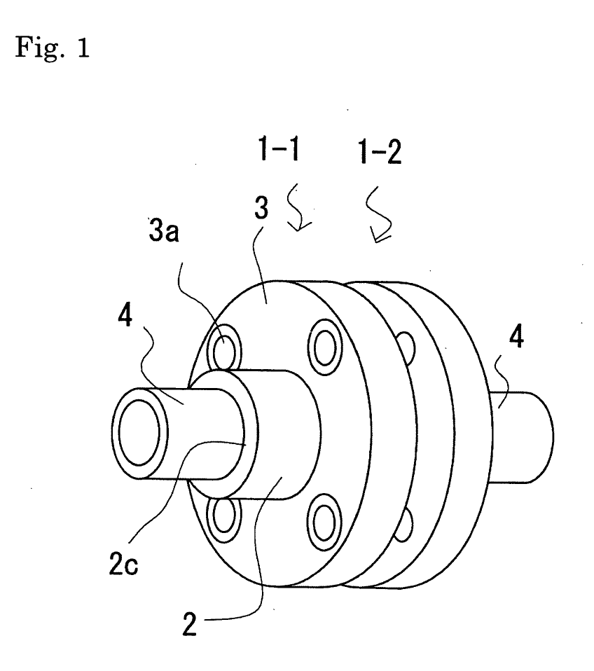

Metal pipe couplings 1-1 and 1-2 according to the present invention have the same shape as one another except a different seal structure due to an O-ring, as is later discussed, namely, they each have a sleeve portion 2 and a loose flange 3, as shown in FIG. 1. Both of them are made of metal materials, such as steel materials. The loose flange 3 is a doughnut-like member whose internal hole has a diameter larger than an outer peripheral diameter of a circular cylindrical portion 2a of one end of the sleeve portion 2. In addition, the loose flange 3 is loosely fitted on the sleeve portion 2, having bolt holes 3a at an equiangular interval. The sleeve portion 2 has an insertion hole 2c in which a metal pipe (for example, a steel pipe) 4 is inserted, the sleeve portion and the pipe being joined with an adhesive agent.

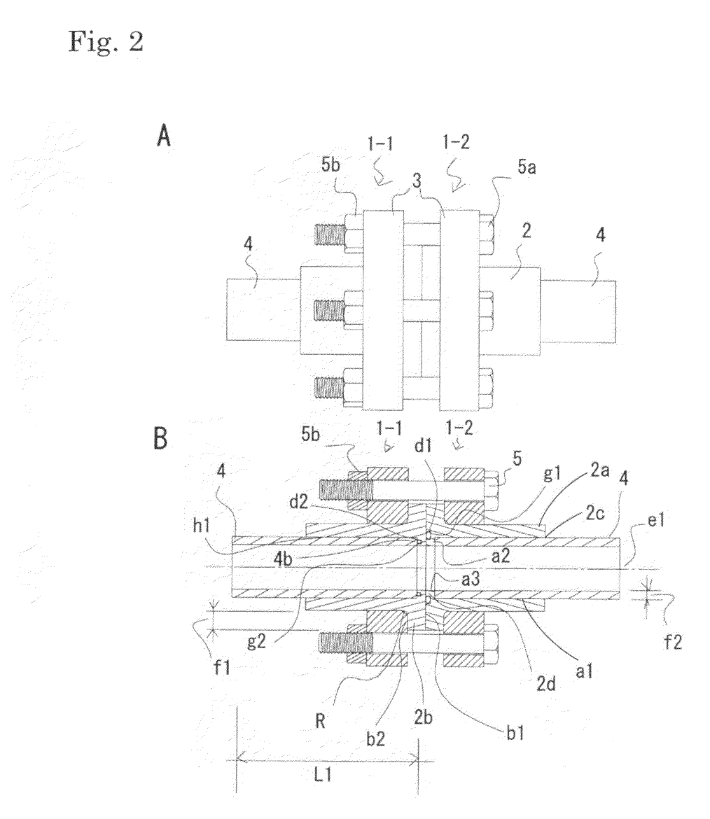

FIG. 2A is a side view and FIG. 2B is a sectional view, wherein the metal pipe couplings 1-1 and 1-2 are joined with bolts 5. The sleeve portion 2 has the circular cylindrical portion 2a at one end and a brim portion 2b at the other end. The cylindrical portion 2a has the insertion hole 2c in which an end 4a of the metal pipe 4 is inserted, and the loose flange 3 is loosely fitted on the outer peripheral surface of the cylindrical portion 2a, the loose flange 3 being freely movably in the direction of the central axis e1 thereof. On the other end of the sleeve portion 2 is provided with a doughnut portion 2d together with the brim portion 2b. The brim portion 2b has an end surface b1 extending radially outward with respect to the central axis e1. The doughnut portion 2d is formed at the deepest position of the insertion hole 2c in the direction of the central axis e1, extending radially inward with respect to the central axis. The insertion hole 2c comprises a sleeve internal peripheral surface a1 and an annular surface a2 of the doughnut portion 2d. The sleeve internal peripheral surface a1 is bonded to the outer periphery of the metal pipe 4 with an adhesive agent h1. The annular surface a2 has a width corresponding to the thickness of the metal pipe 4. When the metal pipe 4 is inserted into the insertion hole 2c, the annular surface a2 is joined to a surface a3 on the same plane as the internal peripheral surface of the metal pipe 4. The surface a3 is parallel to the central axis e1, being joined to one side end surface b1. The thus constructed metal pipe coupling is discussed later.

The brim portion 2b protrudes radially from its end of the sleeve portion 2 by a length f1 that does not interfere with the bolt 5a, the brim portion having the side end surface b1 for securing the sleeve portions together in an airtight manner. An annular surface b2 extends by the length f1 radially outward from the outer peripheral surface of the cylindrical portion 2a, the annular surface b2 being in contact with the flange 3. The cylindrical portion 2a is joined to the brim portion 2b by a fillet R.

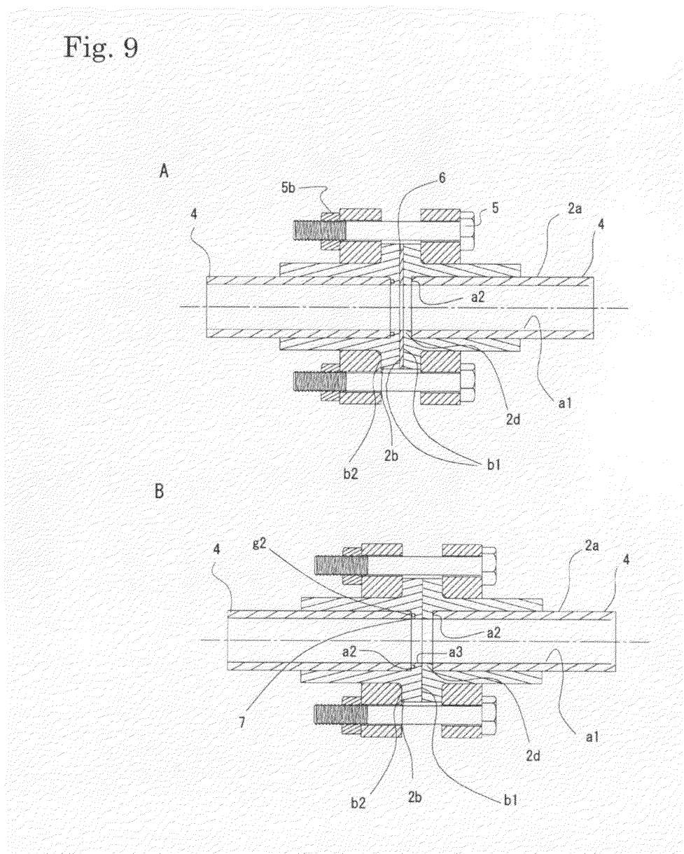

The end surface b1 (of the left side) of the sleeve portion 2 of the metal pipe coupling 1-2 is a plane intersecting the central axis e1 perpendicularly. An O-ring groove g1 for fitting an O-ring d1 is formed concentrically with the insertion hole 2c. Here, the end surface b1 (of the right side) of the sleeve portion 2 of the metal pipe coupling 1-1 is also a plane intersecting the central axis e1 perpendicularly. Accordingly, each of the metal pipe couplings 1-1, 1-2 achieves fluid airtightness by the insertion of the O-ring d1. In addition, in a low pressure pipe, as shown in FIG. 9A, the metal pipe coupling 1-2 is made the same shape as the metal pipe coupling 1-1, which has no O-ring groove g1, and the fluid airtightness between the facing end surfaces b1 is obtained by using a doughnut-plate-like packing 6 having a hollow.

An annular surface a2 of the doughnut portion 2d of the metal pipe coupling 1-1 is a plane intersecting the central axis e1 perpendicularly. An O-ring groove g2 for fitting an O-ring d2 is formed concentrically with the insertion hole 2c. The O-ring d2 achieves fluid airtightness between one side surface 4b of the metal pipe 4 and the annular surface a2. The O-ring d2 can prevent an adhesive agent h1 from dripping from the side surface 4b to the inside of the metal pipe 4. Adhesive agent protruding into and coagulated in the metal pipe 4 may be peeled away by the fluids flowing in the metal pipe 4. If the adhesive agent h1 does not generate an oozy drip, the O-ring groove g2 is unnecessary. In such a case, the metal pipe coupling 1-2 has no O-ring grooves g2. Furthermore, the O-ring groove g2, as shown in FIG. 9B, may be a step 7 having a surface facing in the same direction as the end surface b1, and a bottom surface facing in the same direction as the surface a3. There should be a cavity portion, such as the O-ring groove g2 or the step 7, to accommodate the O-ring d2.

It is clear from the above-described construction that the end surface b1 of the other side of the sleeve portion 2 bridges the brim portion 2b and the doughnut portion 2d.

Although the loose flange 3 and the sleeve portion 2 are separate pieces in this embodiment, they can be unified. The thus constructed metal pipe coupling will be discussed later.

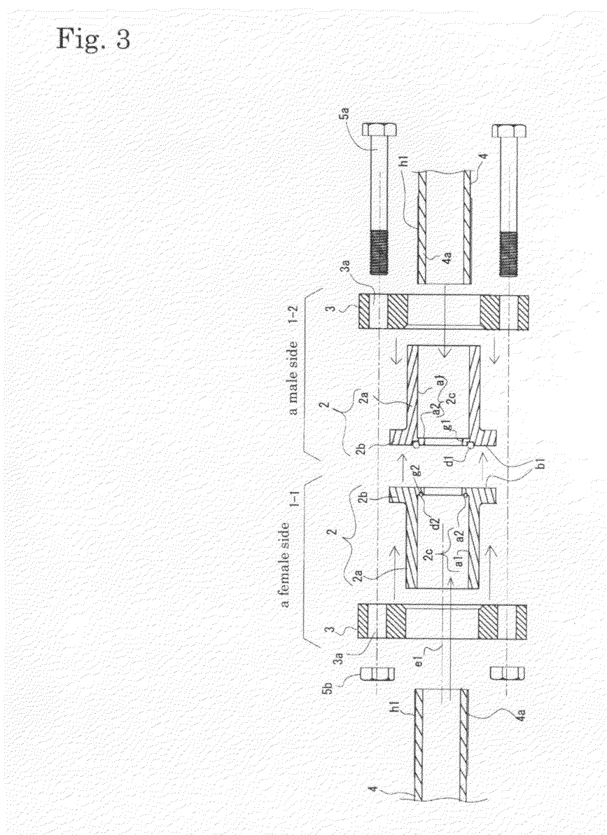

The next example will be explained with reference to FIG. 3, wherein right and left metal pipes (JIS standardized goods) 4 are joined with two metal pipe couplings 1-1, 1-2 to be fluid tight. The metal pipe coupling 1-1 has no O-ring groove g1 on the end surface b1 of the sleeve portion 2, which is the male side. On the other hand, the metal pipe coupling 1-2 has the O-ring groove g1, which is in the female side. Here, the male side and the female side are used as a pain In FIG. 3, the O-ring groove g2 is provided on the metal pipe coupling 1-1, but that is not essential, as was discussed earlier. The O-ring groove g2 may be provided on the female side.

The metal pipes 4 to be coupled are arranged along a line so that their ends 4a face one another. The metal pipes 4 are cut with a disk-cutter, and the tips of the ends 4a are respectively adjusted with a sander grinder so that each rough-cut end surface forms a smooth surface intersecting the length direction of the pipes perpendicularly.

The adhesive agent h1 is applied to at least either the end 4a or the insertion hole 2c (in the figure, to the end 4a), the O-ring d2 is interfitted in the O-ring groove g2, and thereafter, the end 4a of the metal pipe 4 is inserted into the insertion hole 2c of the sleeve portion 2. The tip of the end 4a of the metal pipe 4 contacts the annular surface a2, and then, the adhesive agent h1 is stiffened. For the adhesive agent h1, epoxy resin is preferable.

The insertion hole 2c and the end 4a of the metal pipe 4 in each of the metal pipe couplings 1-1, 1-2 is joined with an adhesive such that the adhesive strength is higher than the tensile strength of the metal pipe 4. Concretely, the length L1 of the sleeve portion 2a (FIG. 1) is selected so that the product of the tensile strength of the adhesive agent h1 times the adhesion area between the outer peripheral surface of the end 4a and the insertion hole 2c is greater than the tensile strength of the metal pipe 4.

A bonding technique for the metal pipe coupling, which makes use of an adhesive agent, has been described in the applicant's prior application (Japanese Patent Application No. 2007-337449). A particularly related feature is concretely explained as follows. That is, the inside diameter of the sleeve internal peripheral surface al is 0.2 mm-0.6 mm larger than the outer diameter of the end 4a of the metal pipe 4. This gap is preferably as uniform as possible. The thickness of the cylindrical portion 2a at the deepest part of the insertion hole 2c (the thickness of the outer peripheral wall of the insertion hole 2c) is determined so as to be stronger than the tensile strength of the metal pipe 4.

Next, the O-ring d1 is interfitted in the ring groove g1, and the side end surfaces b1 of the metal pipe couplings 1-1, 1-2 are placed face-to-face with each other. Under this condition, the bolts 5a are inserted in the bolt holes 3a of the loose flanges 3 from the right and left sides of the metal pipe couplings 1-1, 1-2 so as to bridge them, and the nuts 5b are screwed onto the bolts and fastened. In this way, the right and left loose flanges 3 are pulled and joined.

Thus, two metal pipes 4 are coupled in a fluid-fight manner by applying the adhesive agent h1, fitting each member, then fastening the bolts 5a and the nuts 5b. Accordingly, it is possible to carry out plumbing pipe laying work in an inflammable environment without using fire.

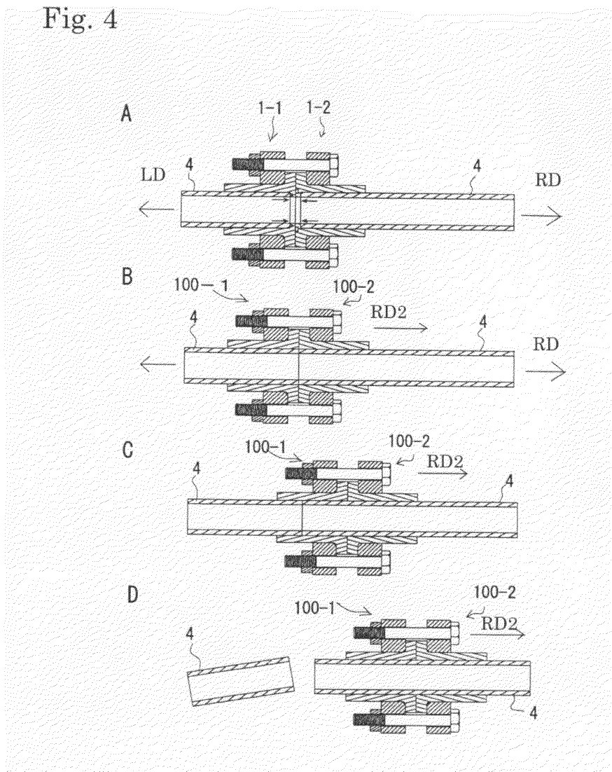

FIGS. 4A-4D are views for explaining the principle that the metal pipe couplings 1-1, 1-2 are detached from the metal pipe 4 even if external forces in the direction of the central axis e1 act on the cylindrical member 2 under a condition in which the adhesive ability of the adhesive agent h1 disappears due to burning or carbonizing. The end of each metal pipe 4 distal to the coupling is fixed to a machine in a plant or to a pipe fixing band, and therefore, movements in the directions “LD”, “RD”, in which the right and left metal pipes 4 separate, are regulated. Accordingly, even if external forces are applied to the metal pipe couplings 1-1, 1-2, the metal pipe couplings 1-1, 1-2 are never moved by the external forces in either of the right and left directions, because the annular surface a2 makes contact with the side surface 4b of the metal pipe 4 (FIG. 4A).

FIG. 4B shows the use of the metal pipe couplings 100-1, 100-2 in which the internal peripheral surface al of each sleeve has no an annular surface a2, and the internal peripheral surface al has the same radius where it reaches the side end surface b1. Where there are no annular surfaces a2, the metal pipe couplings 100-1, 100-2 move in the right or left direction (in this figure: the right direction) by external forces “RD2” as they are coupled (FIG. 4C), and at last get past the position of the coupling surfaces of the metal pipes 4 (FIG. 4D). In this state, the metal pipes 4 are released from coupling, thereby causing fluid to leak from the pipe.

Thus, the sleeve portion 2 is regulated from moving in the direction of the central axis e1 by the contact between the end 4a of each metal pipe 4 and its corresponding annular surface a2. According to this, a sudden leak of the fluid in the metal pipe 4, which is caused by movement of the sleeve portion 2, is prevented, and the pulling-out or falling-out of the cylindrical member 2 or the flange 3, which is caused by a position shift of the metal pipe 4 and the fluid pressure therein, is restricted.

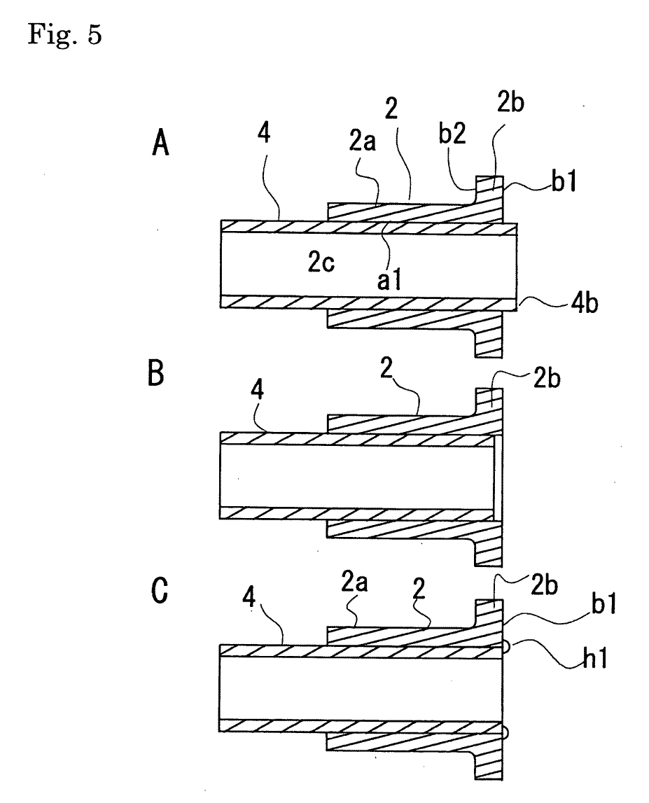

When inserting the metal pipes 4 into the insertion holes 2c of the metal pipe couplings 1-1, 1-2, respectively, each annular surface a2 makes contact with the side surface 4b of the metal pipe 4 and contributes to the positioning of the metal pipe. FIGS. 5A-5C illustrate only the sleeve portion 2, coupled with the metal pipe coupling 100-1, that has no annular surface a2. In FIG. 5A, one side surface 4b of the metal pipe 4 protrudes from the end surface b1 of the sleeve portion 2. In this condition, coupling the metal pipe couplings 1-1, 1-2 is hindered from being airtight. In the case of FIG. 5B, conversely, the side surface 4b does not reach the end surface b1 of the sleeve portion 2, and a pool of the fluid flowing through the metal pipe 4 is formed. When the adhesive agent h1 applied between the sleeve internal peripheral surface a1, and the outer peripheral surface of the metal pipe 4 drips into the fluid pool, the solidified adhesive agent may fall. Even if one side surface 4b of the metal pipe 4 is precisely fitted to the end surface b1 of the sleeve portion 2, excess fluid adhesive agent drips and obstructs the coupling between the metal pipes.

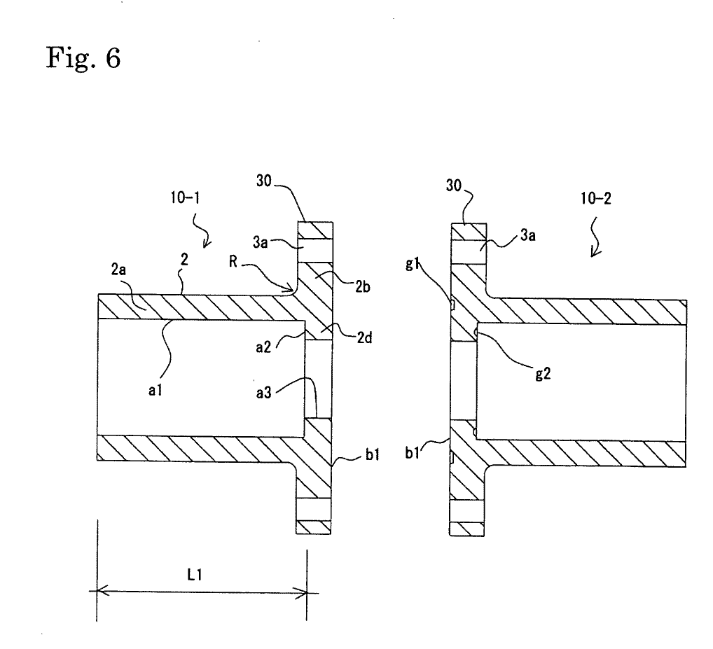

FIG. 6 is an elevation partly in section, showing a metal pipe coupling 10 of another embodiment. In the previous embodiment, a loose flange 3 is provided. On the other hand, in this embodiment, the flange 3 is integrated with the sleeve portion 2 of the previous embodiment. A brim portion 2d of one end of the sleeve portion 2 is further outwardly extended to form a flange 30 having bolt holes. The metal pipe coupling 10-1 is the male side, having no O-ring grooves on the end surface b1, and the metal pipe coupling 10-2 is the female side, having an O-ring groove therein. Here, the male side and the female side work together.

The length L1 of the sleeve internal peripheral surface a1 is so determined that the product of the tensile strength of the adhesive agent h1 times the area of the sleeve internal peripheral surface a1 having a length L1 is greater than the tensile strength of the metal pipe 4. The cylindrical member 2 and the flange 30 perpendicularly rising from the cylindrical member 2 are connected by a fillet R. Here, the member functioning as the loose flange 3 or the flange 30 is called a flange portion.

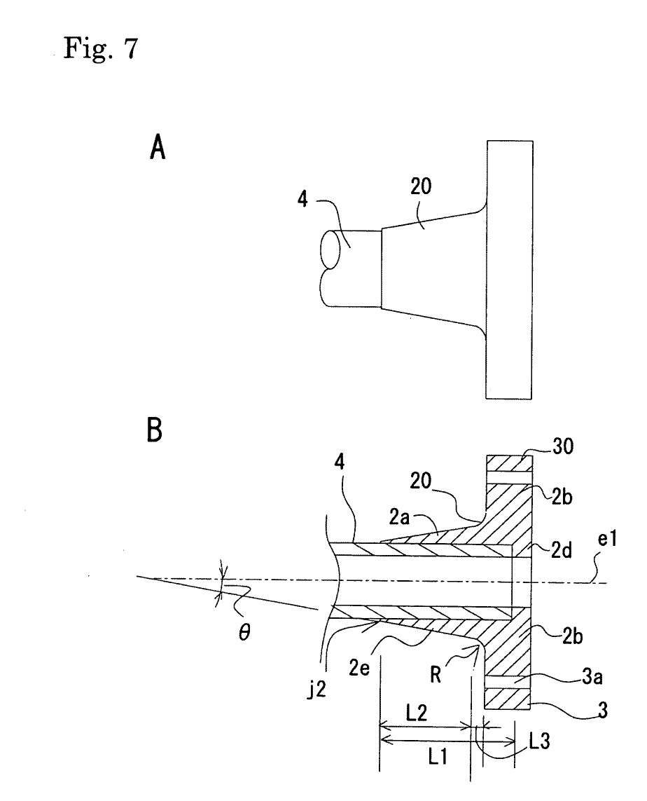

FIG. 7 shows another embodiment. The metal pipe coupling 20 of the embodiment of FIG. 7 is different from the metal pipe coupling 10 of the previous embodiment in that a tapered surface portion 2e, instead of the cylindrical portion 2a, is formed on the outer peripheral surface of the sleeve portion 2. The diameter is diminished by gradually decreasing the thickness toward an entrance of the insertion hole 2c, or enlarged by gradually increasing the thickness from the entrance toward the depth of the sleeve portion. Otherwise, the metal pipe coupling 20 of the embodiment of FIG. 7 has the same constitution as the metal pipe couplings 1, 10 of the previous embodiments. FIG. 7 shows the male side of the metal pipe coupling 20.

The tapered surface portion 2e has an inclination angle θ from the central axis e1 of less than 12 degrees. The thickness of an end point j2 of an entrance side of the insertion hole 2c is reduced to be in the range where one end 4a of the metal pipe 4 can be easily inserted into the insertion hole 2c. For example, it is about 0 mm-3 mm.

As for the metal pipe coupling 20, a tensile load in the direction of the central axis e1 disperses better through the tapered surface portion 2e than it does in the previous embodiment, and stress concentration is controlled. In the metal pipe coupling 20, the tapered surface portion 2e and the flange 30 rising from the tapered surface portion 2e are connected with a fillet R. The curve of the fillet R starts from a position spaced by the length L2 from the end point j2 and continues through the length L3. When the inclination angle θ is less than 12 degrees, the tapered surface portion 2e is warped over an area of 20% of the tapered surface portion from the entrance, where the length from the end point j2 to the depth of the insertion hole 2c is 100%. Accordingly, the length L2 is determined except for a 20% area near the entrance, and then the length L3 is determined.

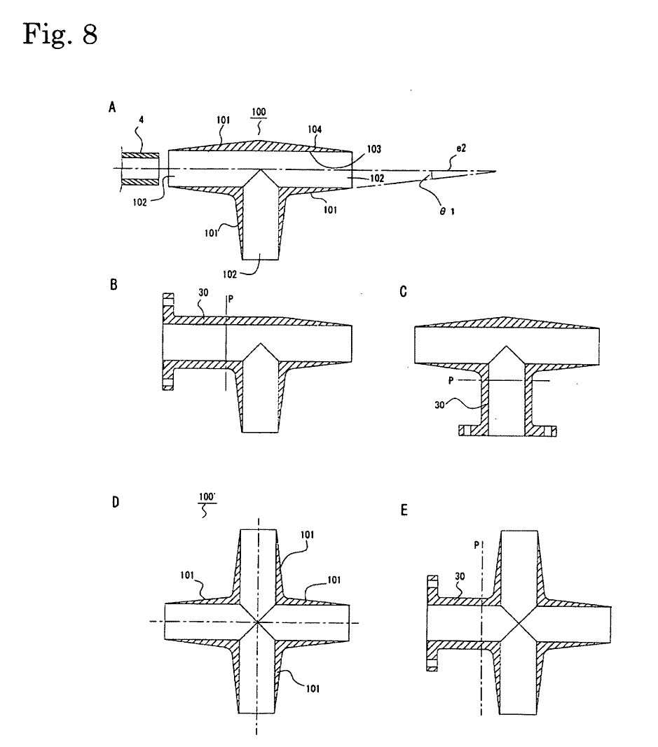

FIGS. 8A-8E show other embodiments. A hub portion 101 of a three-way metal pipe coupling 100 as shown in FIG. 8A and a four-way metal pipe coupling 101 as shown in FIG. 8D are changed to a sleeve portion 30 for applying this embodiment.

In the metal pipe coupling 100, the hub portion 101 has an insertion hole 102 for inserting the metal pipes 4, and an inside peripheral wall 103 of the insertion hole 102 and the outer periphery of the metal pipes 4 are bonded by adhesive agent. The hub portion 101 has a tapered outer peripheral wall 104 whose thickness is increased in the depth direction from the entrance of the insertion hole. The inside diameter of the insertion hole 102 is 0.2 mm-0.6 mm larger than the outside diameter of the metal pipes 4. The adhesion area for adhesive agents between the outer metal pipes 4 and the internal peripheral wall 103 is determined such that the product of the adhesion area times the tensile strength of the adhesive agents is greater than the tensile strength of the metal pipe 4. The tapered surface of the outer peripheral wall 104 has an inclination angle θ from the central axis e2 that is less than 12 degrees. Furthermore, the thickness of the entrance side of the insertion hole 101 is reduced to the range in which the metal pipe 4 can be easily inserted into the insertion hole 102. For example, the thickness is about 0 mm-3 mm.

In FIG. 8B, a hub portion 101 of the left side of the metal pipe coupling 100 is changed to the sleeve portion 30 of the previous embodiment. In FIG. 8B, the portion from the dashed line P to the entrance is changed to the sleeve portion 30. In FIG. 8C, a downward hub portion 101 is changed to the sleeve portion 30. In FIG. 8E, a hub portion of the left side of the four-way metal pipe coupling 100′ is changed to the sleeve portion 30. In addition, depending on the specifications of the metal pipes 4 to be used, more than two hub portions may be changed to sleeve portions 30. Furthermore, changing the hub portion 101 is optional.

In each embodiment of FIGS. 8A-8E, the male side is contemplated. However, it is understood that embodiments of FIGS. 8A-8E can also be applied to the female side. As the coupling for the female side, any of metal pipe couplings 1, 10, 100 can be used.

In the above-mentioned embodiments, the end 4a of the metal pipe 4 can be quenched or cold worked. In this case, this range is defined more than the range to be bonded by the adhesive agent h1. According to these treatments, the end 4a of the metal pipe 4 has its diameter reduced by tension in the direction of the central axis e1, and therefore, the adhesive surface is controlled from transformation, and the strength of the joint is further increased.

1. A flange coupling, comprising:
a sleeve portion having, at one end thereof, an insertion hole having a circular cylindrical surface into which an end of a metal pipe is inserted, and having, at the other end thereof, an end surface extending radially outward with respect to a central axis of the sleeve portion and a doughnut portion extending radially inward at said other end with respect to the central axis and an annular surface having a width in the radial direction that correspond to a wall thickness of the metal pipe;
wherein said doughnut portion has a surface connected to the end surface of the sleeve portion, and the annular surface has a circumferential cavity portion for fitting an O-ring.

2. A flange coupling as claimed in claim 1, further comprising:
a brim portion extending radially outward with respect to the central axis at an outer peripheral portion of said other end of the sleeve portion;
a loose flange positioned around and making contact with an outer peripheral surface of the sleeve portion,
wherein said loose flange has a plurality of bolt holes extending parallel to the central axis at equiangular intervals from one another.

3. A flange coupling as claimed in claim 1, further comprising:
a brim portion extending radially outward with respect to the central axis at an outer peripheral portion of said other end of the sleeve portion;
wherein said brim portion forms a flange having a plurality of bolt holes extending parallel to the central axis at equiangular intervals from one another.

4. A flange coupling as claimed in claim 2, further comprising:
a groove for inserting an O-ring circumferentially on the end surface of the sleeve portion.

5. (canceled)

6. In combination, a flange coupling and a metal pipe, wherein the flange coupling comprises:
a sleeve portion having, at one end thereof, an insertion hole having a circular cylindrical surface into which an end of a metal pipe is inserted, and having, at the other end thereof, an end surface extending radially outward with respect to a central axis of the sleeve portion and a doughnut portion extending radially inward at said other end with respect to the central axis and an annular surface having a width in the radial direction that corresponds to a wall thickness of the metal pipe;
wherein said doughnut portion has a surface connected to the end surface of the sleeve portion, and the annular surface has a circumferential cavity portion for fitting an O-ring, and
wherein an inside diameter of the insertion hole is 0.2 mm-0.6 mm larger than an outside diameter of the metal pipe.

7. A flange coupling as claimed in claim 1, wherein the thickness of the sleeve portion increases gradually from the insertion hole toward said other end of said sleeve portion.

8. A flange coupling as claimed in claim 1, wherein an adhesion area between the metal pipe and the insertion hole is determined such that the product of the adhesion area times the tensile strength of an adhesive to be used in the adhesion area is greater than the tensile strength of the metal pipe.

9. A flange coupling as claimed in claim 8, wherein the end of the metal pipe to be inserted into the insertion hole is quenched in advance.

10. A metal pipe joining structure, comprising:
a metal pipe coupling including
two sleeve portions each having an insertion hole having a circular cylindrical surface at one end thereof and, at the other end thereof, an end surface extending radially outward with respect to a central axis of the sleeve portion, the sleeve portion being formed at its deepest position in the direction of the central axis of the insertion hole with an annular surface extending radially inward with respect to the direction of the central axis and having a width corresponding to a wall thickness of the metal pipe; and
a flange portion having a plurality of bolt holes;
a metal pipe having one end inserted into the insertion hole and one end side surface making contact with the annular surface;
an adhesive agent for bonding an outer peripheral surface of the metal pipe and the circular cylindrical surface; and
bolts and nuts, wherein the bolts pass through the bolt holes, and the end surface of one sleeve portion is drawn to the end surface of the other sleeve portion.

11. A metal pipe joining structure as claimed in claim 10, wherein a groove concentric with the central axis is formed in the end surface of one of the sleeve portions, and an O-ring is inserted in the groove.

12. A method of coupling metal pipes comprising:
forming a metal pipe coupling including two sleeve portions each having at one end thereof an insertion hole having a circular cylindrical surface into which an end of one of a metal pipe is inserted and at the other end thereof an end surface extending radially outward with respect to a central axis of the sleeve portion, and a flange portion having a plurality of bolt holes, one of the sleeve portions being formed at the deepest position from the insertion hole, in the direction of the central axis, of the insertion hole with an annular surface extending radially inward with respect to the central axis, said annular surface having a width corresponding to a wall thickness of the metal pipe and an annular cavity portion concentric with the central axis for fitting an O-ring;
inserting one end of the metal pipe into the insertion hole having the circular cylindrical surface and making the side surface of the one end contact the annular surface;
bonding an outer peripheral surface of the metal pipe and the circular cylindrical surface with an adhesive agent; and
drawing the flange portions toward one another by passing bolts through the bolt holes, screwing nuts onto the bolts and tightening the bolts and nuts relative to one another.

13. A flange coupling as claimed in claim 3, further comprising:
a groove for inserting an O-ring circumferentially on the end surface of the sleeve portion.

14. A flange coupling as claimed in claim 13, further comprising:
a cavity portion for inserting an O-ring circumferentially on the annular surface.
